(19) United States
(12) Patent Application Publication
(10) Pub. No.: US 2021/0110617 A1
(43) Pub. Date: Apr. 15, 2021

(54) METHOD AND APPARATUS FOR PRESENTING AUGMENTED REALITY DATA, DEVICE, STORAGE MEDIUM AND PROGRAM

(71) Applicant: BEIJING SENSETIME TECHNOLOGY DEVELOPMENT CO., LTD., Beijing (CN)

(72) Inventors: Xinru HOU, Beijing (CN); Qing LUAN, Beijing (CN)

(21) Appl. No.: 17/131,988

(22) Filed: Dec. 23, 2020

Related U.S. Application Data
(63) Continuation of application No. PCT/CN2020/111890, filed on Aug. 27, 2020.

(30) Foreign Application Priority Data
Oct. 15, 2019 (CN) 201910979898.4

(51) Int. Cl. G06T 19/00; H04W 4/029; H04W 4/02; G06T 19/20

(52) U.S. Cl. CPC G06T 19/006; G06T 19/20; H04W 4/025; H04W 4/029

(57) ABSTRACT

Provided are a method and apparatus for presenting Augmented Reality (AR) data, an electronic device, a storage medium and a program. The method includes that: position data of an AR device is acquired; in response to detecting that the AR device meets a preset presentation condition for triggering virtual object presentation, presentation data including a moving state of a virtual object is determined based on a movement position of the virtual object and the position data of the AR device; and AR data including the presentation data is presented through the AR device.

### CROSS-REFERENCE TO RELATED APPLICATION

The present application is a continuation of International Patent Application No. PCT/CN2020/111890, filed on Aug. 27, 2020, that is based upon and claims priority to Chinese Patent Application No. 201910979898.4, filed on Oct. 15, 2019. The disclosures of International Patent Application No. PCT/CN2020/111890 and Chinese Patent Application No. 201910979898.4 are hereby incorporated by reference in their entireties.

### BACKGROUND

AR technology is a technology of fusing virtual information and a real world. Generated virtual information, such as a text, an image, a three-dimensional model, music and a video, can be simulated through the AR technology and applied to the real world to implement augmentation of the real world. It is more and more important to optimize an effect of an AR scene presented by an AR device and improve the interactivity with users.

### SUMMARY

The disclosure relates to the field of Augmented Reality (AR), but not limited to a method and apparatus for presenting AR data, an electronic device, a non-transitory computer-readable storage medium and a computer program.

A first aspect of the disclosure provides a method for presenting AR data, which may include that:

position data of an AR device is acquired;

in response to detecting that the AR device meets a preset presentation condition for triggering virtual object presentation, presentation data including a moving state of a virtual object is determined based on a movement position of the virtual object and the position data of the AR device; and

AR data including the presentation data is presented through the AR device.

A second aspect of the disclosure provides a method for presenting AR data, which may include:

position data of n first AR devices is acquired, n being a positive integer;

in response to detecting that m first AR devices in the n first AR devices meet a preset presentation condition for triggering virtual object presentation, presentation data matched with the m first AR devices respectively and including a moving state of a virtual object is determined based on a movement position of the virtual object and the position data of the m first AR devices, m being a positive integer less than or equal to n; and

AR data including the presentation data matched with the m first AR devices respectively is presented through the m first AR devices.

A third aspect of the disclosure provides an apparatus for presenting AR data, which may include a position data acquisition module, a presentation data determination module and a first presentation module.

The position data acquisition module may be configured to acquire position data of an AR device.

The presentation data determination module may be configured to, in response to detecting that the AR device meets a preset presentation condition for triggering virtual object presentation, determine presentation data including a moving state of a virtual object based on a movement position of the virtual object and the position data of the AR device.

The first presentation module may be configured to present AR data including the presentation data through the AR device.

A fourth aspect of the disclosure provides an apparatus for presenting AR data, which may include a first acquisition module, a first determination module and a second presentation module.

The first acquisition module may be configured to acquire position data of n first AR devices, n being a positive integer.

The first determination module may be configured to, in response to detecting that m first AR devices in the n first AR devices meet a preset presentation condition for triggering virtual object presentation, determine presentation data matched with the m first AR devices respectively and including a moving state of a virtual object based on a movement position of the virtual object and the position data of the m first AR devices, m being a positive integer less than or equal to n.

The second presentation module may be configured to present AR data including the presentation data matched with the m first AR devices respectively through the m first AR devices.

A fifth aspect of the disclosure provides an electronic device, which may include a processor, a memory and a bus. The memory may store a machine-readable instruction executable by the processor. When the electronic device runs, the processor may communicate with the memory through the bus. The machine-readable instruction may be executed by the processor to execute the method for presenting AR data as described in the first aspect or any implementation mode, or, the machine-readable instruction may be executed by the processor to execute the method for presenting AR data as described in the second aspect or any implementation mode.

A sixth aspect of the disclosure provides a non-transitory computer-readable storage medium, in which a computer program may be stored. The computer program may be operated by a processor to execute the method for presenting AR data as described in the first aspect or any implementation mode, or, the computer program may be executed by the processor to execute the method for presenting AR data as described in the second aspect or any implementation mode.

A seventh aspect of the disclosure provides a computer program, which may include a computer-readable code. When the computer-readable code runs in an electronic device, a processor in the electronic device may execute any of abovementioned methods for presenting AR data.

In order to make the purpose, characteristics and advantages of the disclosure clearer and easier to understand, detailed descriptions will be made below with embodiments in combination with the drawings.

### BRIEF DESCRIPTION OF THE DRAWINGS

For describing the technical solutions of the embodiments of the disclosure more clearly, the drawings required to be used in the embodiments will be simply introduced below. The drawings, which are incorporated in and constitute a part of this specification, illustrate embodiments consistent with the disclosure and, together with the specification, serve to explain the technical solutions of the disclosure. It is to be understood that the following drawings only illustrate some embodiments of the disclosure and thus should not be considered as limits to the scope. Those of ordinary skill in the art may also obtain other related drawings according to these drawings without creative work.

FIG. 1 is a flowchart of a method for presenting AR data according to an embodiment of the disclosure.

FIG. 2A is a schematic diagram of an initial moving path according to an embodiment of the disclosure.

FIG. 2B is a schematic diagram of an updated moving path obtained based on an initial moving path according to an embodiment of the disclosure.

FIG. 3A is a schematic diagram of an image in presentation data of an AR device according to an embodiment of the disclosure.

FIG. 3B is a schematic diagram of another image in presentation data of an AR device according to an embodiment of the disclosure.

FIG. 4 is a flowchart of another method for presenting AR data according to an embodiment of the disclosure.

FIG. 5A is a schematic diagram of a moving path according to an embodiment of the disclosure.

FIG. 5B is a schematic diagram of an updated moving path according to an embodiment of the disclosure.

FIG. 6 is a structure diagram of an apparatus for presenting AR data according to an embodiment of the disclosure.

FIG. 7 is a structure diagram of another apparatus for presenting AR data according to an embodiment of the disclosure.

FIG. 8 is a structure diagram of a first electronic device according to an embodiment of the disclosure.

FIG. 9 is a structure diagram of a second electronic device according to an embodiment of the disclosure.

### DETAILED DESCRIPTION

In order to make the purpose, technical solutions and advantages of the embodiments of the disclosure clearer, the technical solutions in the implementation modes will be clearly and completely described below in combination with the drawings in the implementation modes. It is apparent that the described embodiments are not all embodiments but only part of embodiments of the disclosure. Components, described and shown in the drawings, of the embodiments of the disclosure may usually be arranged and designed with various configurations. Therefore, the following detailed descriptions about the embodiments of the disclosure in the drawings are not intended to limit the claimed scope of the disclosure but only represent selected embodiments of the disclosure. All other embodiments obtained by those skilled in the art on the basis of the embodiments in the disclosure without creative work shall fall within the scope of protection of the disclosure.

For improving an optimization effect of a presented AR scene and the flexibility in presentation of the AR scene, the embodiments of the disclosure provide a method for presenting AR data. Presentation data including a moving state of a virtual object may be determined based on a movement position of the virtual object and position data of an AR device, and AR data including the presentation data may be presented through the AR device, so that presentation of an AR scene by the AR device is implemented.

For making the embodiments of the disclosure convenient to be understood, a method for presenting AR data provided in the embodiments of the disclosure will be introduced at first in detail.

According to the method for presenting AR data provided in the embodiments of the disclosure, presentation data corresponding to a moving state of a virtual object to be presented in an independent AR device may be acquired based on position data of the AR device, or presentation data corresponding to moving states of virtual objects to be presented in multiple AR devices respectively may be determined by unified calculation of position data of the multiple AR devices in a reality scene. Exemplarily, when there are multiple AR devices, a moving state of a virtual object presented in each AR device may be a moving state influenced by position data of other AR devices.

In the embodiments of the disclosure, the AR device may be an intelligent device capable of supporting an AR function. Exemplarily, the AR device includes, but not limited to, an electronic device capable of presenting an AR effect, such as a mobile phone, a tablet computer and AR glasses.

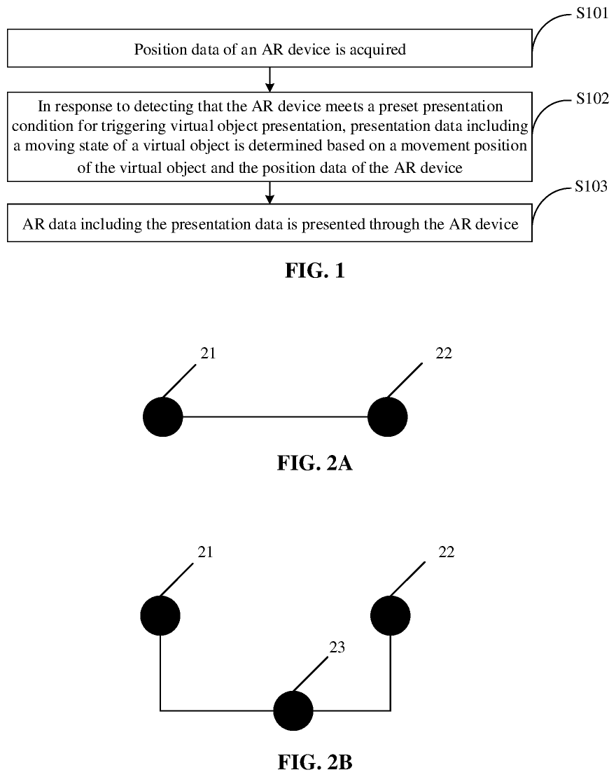

Referring to FIG. 1, a flowchart of a method for presenting AR data according to an embodiment of the disclosure is shown. The method may be applied to the abovementioned AR device or applied to a local or cloud server.

The method for presenting AR data shown in FIG. 1 includes the following steps.

In step S101, position data of an AR device is acquired.

In step S102, in response to detecting that the AR device meets a preset presentation condition for triggering virtual object presentation, presentation data including a moving state of a virtual object is determined based on a movement position of the virtual object and the position data of the AR device.

In step S103, AR data including the presentation data is presented through the AR device.

Based on the above steps, the presentation data including the moving state of the virtual object may be determined, and the AR data including the presentation data may be presented through the AR device. In such a manner, the moving state of the virtual object matched with a position of the AR device may be presented through the AR device, for example, an AR effect that the virtual object moves to the position of the AR device may be presented, so that presentation of the virtual object can be fused to a reality scene better, and the flexibility in presentation of the AR data is improved.

S101 to S103 will be respectively described below.

For step S101:

In the embodiment of the disclosure, the position data of the AR device includes position data of the AR device in a reality scene. The position data may be three-dimensional coordinate data of the AR device in a preset reference coordinate system, or may also be latitude and longitude data corresponding to the AR device.

Exemplarily, a method for acquiring the position data of the AR device includes, but not limited to, a Global Positioning System (GPS), a satellite positioning system and the like. Or, a present reality scene image may be acquired through the AR device, and a practical geographical position may be determined based on the reality scene image. For example, image recognition may be performed on the reality scene image to determine geographical position information in a reality scene corresponding to the reality scene image. Specifically, during image recognition, recognition may be performed based on a pre-trained position prediction model, or recognition may be performed in a manner of comparing the reality scene image and a pre-stored sample image.

For step S102:

In the implementation mode, initial presentation data including the moving state of the virtual object may be determined based on the movement position of the virtual object and a preset initial moving path of the virtual object. After the position data of the AR device is acquired, the initial moving path of the virtual object may not be modified in response to detecting that the AR device does not meet the preset presentation condition for triggering virtual object presentation, and furthermore, the initial presentation data is not modified. In response to detecting that the AR device meets the preset presentation condition for triggering virtual object presentation, a new moving path of the virtual object may be generated based on the movement position of the virtual object and the position data of the AR device, the presentation data including the moving state may be modified based on the new moving path, and an updated moving state of the virtual object can be presented in the present AR scene.

Exemplarily, FIG. 2A is a schematic diagram of an initial moving path. The initial moving path in FIG. 2A includes a preset initial position 21 of the virtual object and a preset end position 22 of the virtual object. In response to detecting that the AR device meets the preset presentation condition for triggering virtual object presentation, the new moving path of the virtual object may be generated based on the position data of the AR device. There are multiple situations for the new moving path of the virtual object. Exemplarily, FIG. 2B shows one situation. It can be seen from FIG. 2B that the new moving path of the virtual object includes the preset initial position 21, the preset end position 22 of the virtual object and a position 23 of the AR device.

In some embodiments of the disclosure, the movement position of the virtual object includes at least one of the following positions: a preset initial position of the virtual object, a preset end position of the virtual object and a position of the virtual object in a present moving state.

During specific implementation, the preset initial position of the virtual object and the preset end position of the virtual object may be set based on a practical circumstance. The position of the virtual object in the present moving state may be a real-time position of the virtual object in a three-dimensional scene model when the presentation data is determined. Here, the three-dimensional model is a model configured to represent a reality scene. Morphological characteristics of the reality scene may be comprehensively described in the model. A scale of the three-dimensional scene model to the reality scene is usually 1:1. Designing a special presentation effect of the virtual object in the reality scene based on the three-dimensional scene model may improve fusion of a special presentation effect of a virtual scene and the reality scene.

In response to determining the moving state, a moving path matched with the position data of the AR device and the movement position of the virtual object may be generated based on the position data of the AR device and the movement position of the virtual object, for example, a moving path that starts from the present real-time position or preset initial position of the virtual object, passes by the position of the AR device and ends at the preset end position of the virtual object is generated, and furthermore, a moving state of the virtual object along with the moving path is presented in a present AR scene. It can be seen that, in such a manner of generating the moving path of the virtual object based on the position of the AR device and presenting the moving state based on the moving path, the diversity and flexibility in state presentation of the virtual object are improved, and fusion of the virtual object into the reality scene is improved, namely the presentation effect of the AR scene is improved.

In some embodiments of the disclosure, the preset presentation condition may include that the position data of the AR device is in a target regional range. The target regional range may be a regional range including the virtual object, or may be a regional range not including the virtual object. Exemplarily, the target regional range may be a preset irregular regional range, or may also be a circular region taking the position of the virtual object as a center and taking a preset distance as a radius.

In the implementation mode, detecting whether the AR device meets the preset presentation condition for triggering virtual object presentation may include: determining whether a preset regional range includes the position data of the AR device or not, and if YES, determining the AR device meets the preset presentation condition. Or, detecting whether the AR device meets the preset presentation condition for triggering virtual object presentation may include: determining whether a distance between the position of the AR device and the position of the virtual object is less than or equal to the preset distance, and if YES, determining the AR device meets the preset presentation condition. A manner for determining whether the AR device meets the preset presentation condition is not limited in the disclosure.

In some embodiments of the disclosure, the preset presentation condition may include that the position data of the AR device is in a target regional range and attribute information of a user associated with the AR device satisfies a preset attribute condition.

In the implementation mode, the user associated with the AR device includes, but not limited to, an owner of the AR device, an operator of the AR device and a user at a distance less than a preset distance threshold away from the AR device.

In some embodiments of the disclosure, attribute information corresponding to the preset attribute condition may be selected from the attribute information of the user associated with the AR device as first attribute information of the AR device, and whether the AR device satisfies the preset attribute condition or not may be determined based on the first attribute information of the AR device.

In some embodiments of the disclosure, the attribute information may include, but not limited to, at least one of: age of the user, gender of the user, occupational attribute of the user, and interested virtual object information preset by the user.

In the implementation mode, the attribute information of the user may be determined in, but not limited to, the following implementation manners.

A first manner: the attribute information of the user is determined based on registration data corresponding to the AR device.

A second manner: the attribute information of the user is determined based on behavioral data detected by the AR device.

A third manner: the attribute information of the user is determined through an image recognition technology.

Exemplarily, the registration data may be data input by the user when the AR device is used. For example, when the AR device is a mobile phone, the registration data may be basic information the user fills in when using software with an AR scene presentation function.

Exemplarily, the behavioral data may be data stored in the AR device. For example, the behavioral data may be a type of software browsed by the user, a duration of browsing the software and the like. Or, the behavioral data may also be data detected by the AR device in real time, for example, a triggering operation, such as a gesture operation, a voice operation and a key operation, detected by the AR device and executed on the AR device by the user.

Exemplarily, the attribute information may include, but not limited to, the age, height, dressing, expression and the like of the user. In a possible implementation mode, a process of determining the attribute information of the user through the image recognition technology may include that: image data of the user is acquired, and the attribute information of the user is acquired from the image data of the user based on the image recognition technology. The image data may be acquired in a manner of, for example, acquiring through a built-in camera (for example, a front camera) of the AR device or acquiring through a camera deployed in the reality scene and independent of the AR device, or may also be acquired through image data, transmitted to the AR device through another device, of the user. During specific implementation, the attribute information of the user is set, and then a server or the AR device may locate a matched virtual object to be presented for the AR device based on the attribute information of the user or determine whether to locate matched presentation data for the AR device based on the attribute information of the user, so that an effect of presenting different presentation data for different AR devices is achieved, and the presentation effect is improved.

For example, when the preset attribute condition is that the user gender is female, under the circumstance that the position data of the AR device is in the target regional range and the first attribute information of the user associated with the AR device is that “the user gender is female”, the AR device meets the preset presentation condition; and under the circumstance that the position data of the AR device is not in the target regional range or the first attribute information of the user associated with the AR device is that “the user gender is male”, the AR device does not meet the preset presentation condition. The preset presentation condition is set to select AR devices, and presentation data including a moving state of a virtual object can be determined based on position data of an AR device meeting the preset presentation condition and the presentation data is presented on the corresponding AR device, so that the flexibility in presentation of the AR scene is improved.

In some embodiments of the disclosure, the operation that the presentation data including the moving state of the virtual object is determined based on the movement position of the virtual object and the position data of the AR device may include:

the moving path of the virtual object is acquired based on the movement position of the virtual object and the position data of the AR device; and

the presentation data including the moving state of the virtual object is determined based on the moving path and special effect data of the virtual object in a three-dimensional scene model matched with a reality scene.

During specific implementation, a process of generating the moving path of the virtual object may be executed in the AR device, or may be executed in a server. The AR device or the server may set a path planning algorithm to generate the moving path of the virtual object based on the movement position of the virtual object and the position data of the AR device. Then, the AR device, after acquiring the locally generated moving path of the virtual object or acquiring the moving path, generated by the server, of the virtual object, may fuse the special effect data of the virtual object in the three-dimensional scene model matched with the reality scene and the acquired moving path to determine the presentation data including the moving state of the virtual object.

In some embodiments of the disclosure, the method for presenting AR data may further include that a corresponding matched virtual object is located for the AR device based on the attribute information of the user associated with the AR device. A specific process is as follows.

In response to detecting that the AR device meets the preset presentation condition for triggering virtual object presentation, a virtual object matched with attribute information of a user associated with the AR device is determined based on the attribute information.

In the implementation mode, when there are multiple virtual objects, the virtual object corresponding to the AR device may be determined based on the attribute information of the user associated with the AR device. One or more types of attribute information may be selected from the attribute information of the user as second attribute information of the AR device, and a matched virtual object may be located for the AR device based on the second attribute information. The second attribute information may be the same as or different from the first attribute information adopted when whether the AR device satisfies the preset attribute condition is determined. The circumstance that the first attribute information is different from the second attribute information is exemplarily described: when the first attribute information is that the user gender is female, the second attribute information may be the user age, and different virtual objects may be matched with the user based on different user ages. Specifically, when the user age is 3 to 10, the corresponding virtual object may be a cartoon animal; when the user age is 11 to 18, the corresponding virtual object may be a game character; when the user age is 19 to 30, the corresponding virtual object may be stars; and so on. The circumstance that the first attribute information is the same as the second attribute information is exemplarily described: taking the circumstance that both the first attribute information and the second attribute information are the user age as an example, when the first attribute information is that the user age is under 20 (20 is included) and the second attribute information is that the user age is under 5, the corresponding virtual object is a cartoon animal; when the user age is 5 to 10 (5 is included but 10 is not included), the corresponding virtual object is a cartoon figure; and when the user age is 10 to 20 (10 and 20 are included), the corresponding virtual object is a movie/television star.

Users with different attribute information may be matched with different virtual objects, and furthermore, different presentation data may be generated for different AR devices based on different virtual objects, so that the diversity of the presentation data is achieved, and the presentation effect of the AR device is improved.

In some embodiments of the disclosure, the moving state of the virtual object may also be customized for a user based on a user requirement. For example, when AR device 1 acquires indication information about an interest in star 1, presentation data including a moving state of the star 1 can be generated; and when AR device 2 acquires indication information about an interest in star 2, presentation data including a moving state of the star 2 can be generated.

In the above description, after a virtual object matched with the attribute information is determined, presentation data including a moving state of the virtual object can be generated based on a movement position of the matched virtual object and the position data of the AR device, including the following operations:

the movement position of the virtual object matched with the attribute information is acquired; and

the presentation data including the moving state of the virtual object is determined based on the movement position of the virtual object matched with the attribute information and the position data of the AR device.

In the implementation mode, movement positions of different virtual objects may be the same or may be different, and the movement position of the virtual object may be set according to a practical requirement. After the matched virtual object is determined based on the attribute information of the user associated with the AR device, the movement position of the virtual object matched with the attribute information is acquired, then a moving path of the virtual object matched with the attribute information is generated based on the acquired movement position of the virtual object and the position data of the AR device, and finally, the presentation data including the moving state of the virtual object matched with the attribute information is determined based on the moving path and special effect data of the virtual object matched with the attribute information in the three-dimensional scene model matched with the reality scene.

For S103

In the embodiment of the disclosure, the AR data includes presentation data, for example, an animation formed by multiple frames of images or a single-frame image, and the AR data may also include sound data, synthetic smell data and the like. Exemplarily, the sound data may be set at a preset frame image position in the presentation data to fuse the sound data and the presentation data.

For example, when the virtual object presented in the presentation data moves to the position of the AR device, the AR device plays preset sound data. Exemplarily, the sound data may be “ [symbol] , [symbol] [symbol] (Hello, welcome to fairy world)”. Displaying of both the sound data and the presentation data on the AR device is implemented, and the presentation effect of AR data on the AR device is improved.

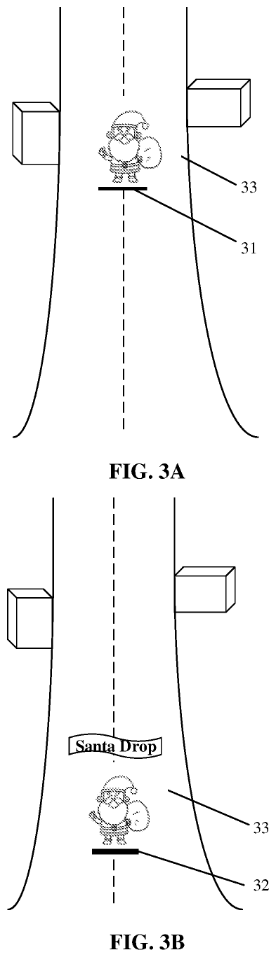

Exemplarily, FIG. 3A is a schematic diagram of an image in presentation data of an AR device, and FIG. 3B is a schematic diagram of another image in presentation data of an AR device. It can be seen from FIG. 3A and FIG. 3B that a virtual object 33 moves from a position point 31 to a position point 32, special effect of the virtual object 33 at the position point 31 is different from special effect data at the position point 32, and when the virtual object moves to the position point 32, sound data may be set and the AR device plays the sound data “ [symbol] , [symbol] (Santa Drop)”.

According to the method for presenting AR data provided in the embodiment of the disclosure, presentation data matched with a single AR device and including a moving state of a virtual object is generated for the AR device, and the virtual object in the presentation data is in the moving state based on a moving path, namely the virtual object in the presentation data is dynamic, so that the AR device can present AR data including the presentation data, and a presentation effect of the AR data in the AR device is improved.

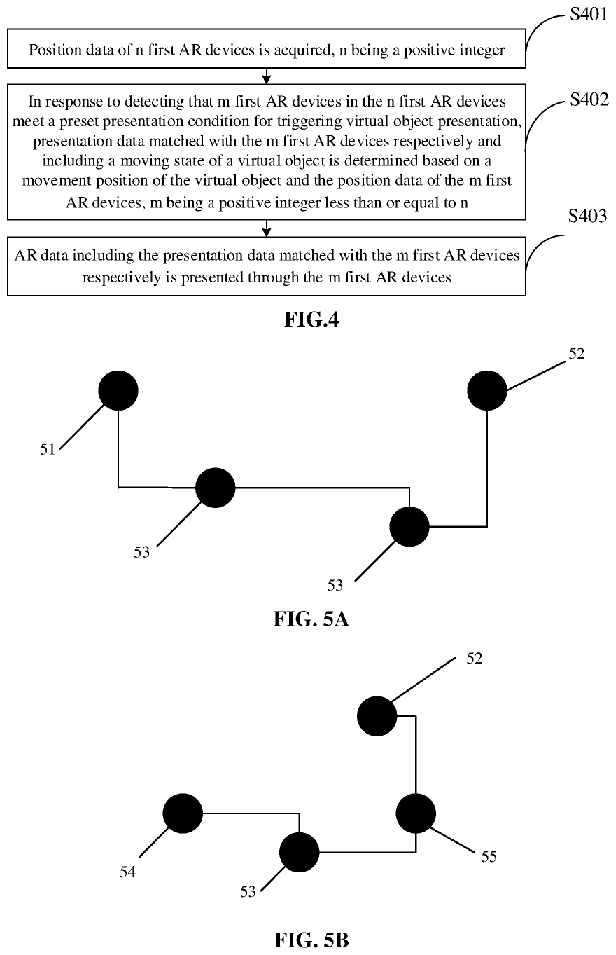

Referring to FIG. 4, a flowchart of another method for presenting AR data according to an embodiment of the disclosure is shown. The method may be applied to a server. The method may be applied to presentation of AR data through multiple AR devices. The method for presenting AR data shown in FIG. 4 includes steps S401 to S403. A specific process is as follows.

In S401, position data of n first AR devices is acquired, n being a positive integer.

In the embodiment of the disclosure, position data of each AR device in the n first devices is acquired. The position data of the first AR devices may be acquired through a GPS and a satellite positioning system. If a AR devices in the n AR devices are associated AR devices, a being a positive integer less than or equal to n, the position data of any AR device in the associated AR devices may be acquired as the position data of each AR device in the associated AR devices. For the associated AR devices, a user may manually associate the a AR devices, or a server may automatically associate the AR devices meeting an association condition. For example, the association condition may be that the AR devices are connected with the same signal.

In S402, in response to detecting that m first AR devices in the n first AR devices meet a preset presentation condition for triggering virtual object presentation, presentation data matched with the m first AR devices respectively and including a moving state of a virtual object is determined based on a movement position of the virtual object and the position data of the m first AR devices, m being a positive integer less than or equal to n.

In the embodiment of the disclosure, a moving path of the virtual object is generated based on the movement position of the virtual object and the position data of the m first AR devices, and the presentation data corresponding to each first AR device in the m first AR devices and including the moving state of the virtual object is determined based on the moving path and special effect data of the virtual object in a three-dimensional scene model matched with a reality scene.

In some embodiments of the disclosure, the presentation data may include a moving state presented in a process that the virtual object moves along with a moving path; and points that the moving path passes by may include positions of the m first AR devices, or, the points that the moving path passes by may include position points in a preset distance range away from the positions of the m first AR devices respectively.

In the embodiment of the disclosure, a value of m may be updated with change of the number of AR devices practically meeting the preset presentation condition. Specifically, when the position data of any AR device in the first AR devices does not meet the preset presentation condition, the points that the moving path passes by do not include the AR device not meeting the preset presentation condition, and in such case, the value of m changes. Exemplarily, if the value of m at an initial moment is 3, when the position data of any first AR device in the three first AR devices does not meet the preset presentation condition, namely the position data of a first AR device in the three first AR devices is out of a target regional range, the value of m changes, and the value of m at this moment is 2. In such case, the presentation data matched with the other two first AR devices respectively and including the moving state of the virtual object is determined based on the position data of the two first AR devices and the movement position of the virtual object. The presentation data includes the moving state presented in a process that the virtual object moves along with the moving path. The points that the moving path passes by include the positions of the two first AR devices.

In some embodiments of the disclosure, the method for presenting AR data may further include:

position data of a second AR device is acquired; and

in response to detecting that the second AR device meets the preset presentation condition, the presentation data including the moving state of the virtual object is updated based on a position of the virtual object in a present moving state, the position data of the second AR device and the position data of a first AR device that the moving path before updated does not pass by in the m first AR devices.

In the implementation mode, after the presentation data matched with the m first AR devices respectively and including the moving state of the virtual object is determined based on the movement position of the virtual object and the position data of the m first AR devices, a server, when detecting the second AR device, can acquire the position data of the second AR device; and when the second AR device meets the preset presentation condition, the server may update the presentation data including the moving state of the virtual object. The second AR device is other AR device than the first AR devices.

Exemplarily, as shown in FIG. 5A, FIG. 5A is a schematic diagram of a moving path. It can be seen from 5A that the value of m is 2 and FIG. 5A includes a preset initial position 51 of the virtual object, a preset end position 52 of the virtual object and positions 53 of two first AR devices. When the position data of the second AR device is detected at a certain moment, the position data of the second AR device may be acquired, and when the second AR device meets the preset presentation condition, the moving path shown in FIG. 5A may be updated based on the position of the virtual object in the present moving state, the position data of the second AR device and position data of a first AR device that the moving path before updated does not pass by in the two first AR devices. There are multiple situations for the updated moving path corresponding to the moving path shown in FIG. 5A. Any one of the situations is exemplarily described, and the updated moving path is shown in FIG. 5B. It can be seen from FIG. 5B that FIG. 5B includes the position 54 of the virtual object in the present moving state, a position 55 of the second AR device, the preset end position 52 of the virtual object and the position 53 of the first AR device that the moving path before updated does not pass by. Furthermore, the presentation data including the moving state of the virtual object is updated based on the updated moving path.

In S403, AR data including the presentation data matched with the m first AR devices respectively is presented through the m first AR devices.

Exemplarily, following the example in S402, if the value of m is 2, the server may generate the presentation data matched with the two first AR devices respectively and including the moving state of the virtual object and send the two pieces of presentation data to the corresponding first AR devices respectively to enable the first AR devices to present corresponding AR data including the presentation data.

According to the method for presenting AR data provided in the disclosure, presentation data matched with multiple AR devices respectively and including a moving state of a virtual object may be generated based on the multiple AR devices, and then the multiple AR devices may receive the presentation data including the moving state of the virtual object in a target region and present AR data including the presentation data, so that the virtual object may be flexibly presented in the multiple AR devices, a requirement of a reality scene is met, and a presentation effect of the AR data is improved.

It can be understood by those skilled in the art that, in the method of the specific implementation modes, the sequence of each step does not mean a strict execution sequence and is not intended to form any limit to the implementation process and a specific execution sequence of each step should be determined by functions and probable internal logic thereof.

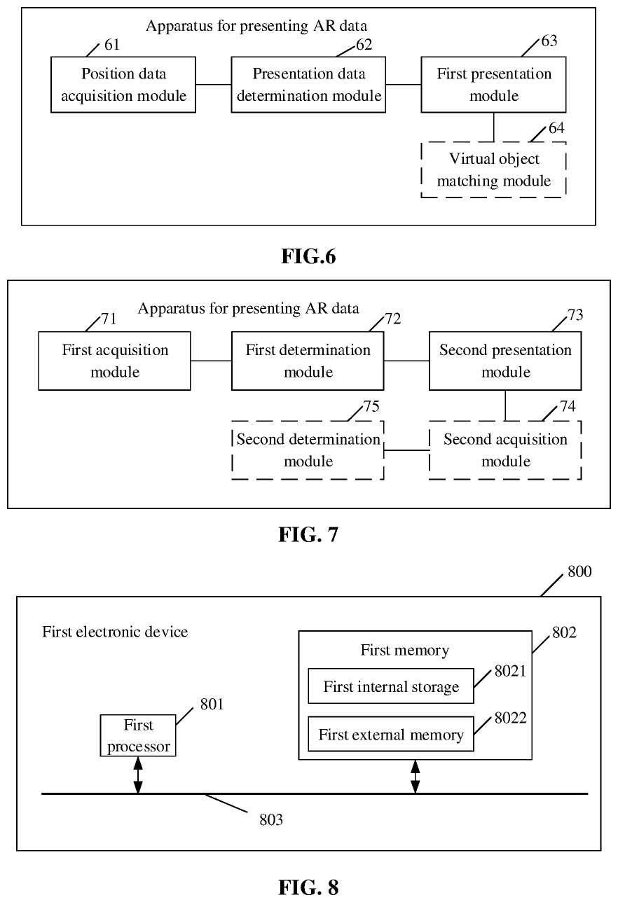

Based on the same concept, the embodiments of the disclosure also provide an apparatus for presenting AR data. Referring to FIG. 6, a structure diagram of an apparatus for presenting AR data according to an embodiment of the disclosure is shown. A position data acquisition module 61, a presentation data determination module 62 and a first presentation module 63 are included, specifically as follows.

The position data acquisition module 61 is configured to acquire position data of an AR device.

The presentation data determination module 62 is configured to, in response to detecting that the AR device meets a preset presentation condition for triggering virtual object presentation, determine presentation data including a moving state of a virtual object based on a movement position of the virtual object and the position data of the AR device.

The first presentation module 63 is configured to present AR data including the presentation data through the AR device.

In a possible implementation mode, the movement position of the virtual object in the presentation data determination module 62 includes at least one of the following positions:

a preset initial position of the virtual object, a preset end position of the virtual object, and a position of the virtual object in a present moving state.

In a possible implementation mode, the preset presentation condition in the presentation data determination module 62 may include that the position data of the AR device is in a target regional range.

In a possible implementation mode, the preset presentation condition in the presentation data determination module 62 may include that the position data of the AR device is in a target regional range and attribute information of a user associated with the AR device satisfies a preset attribute condition.

In a possible implementation mode, the presentation data determination module 62 determines the presentation data including the moving state of the virtual object by steps of:

acquiring a moving path of the virtual object based on the movement position of the virtual object and the position data of the AR device; and

generating the presentation data comprising the moving state of the virtual object based on the moving path and special effect data of the virtual object in a three-dimensional scene model matched with a reality scene.

In a possible implementation mode, the apparatus may further include a virtual object matching module 64.

The virtual object matching module 64 is configured to, in response to detecting that the AR device meets the preset presentation condition for triggering virtual object presentation, determine a virtual object matched with attribute information of a user associated with the AR device based on the attribute information.

The presentation data determination module 62 determines the presentation data including the moving state of the virtual object by steps of:

acquiring the movement position of the virtual object matched with the attribute information; and

determining the presentation data comprising the moving state of the virtual object based on the movement position of the virtual object matched with the attribute information and the position data of the AR device.

In a possible implementation mode, the attribute information may include at least one of: age of the user, gender of the user, occupational attribute of the user, and interested virtual object information preset by the user.

Based on the same concept, the embodiments of the disclosure also provide another apparatus for presenting AR data. Referring to FIG. 7, a structure diagram of another apparatus for presenting AR data according to an embodiment of the disclosure is shown. A first acquisition module 71, a first determination module 72 and a second presentation module 73 are included, specifically as follows.

The first acquisition module 71 is configured to acquire position data of n first AR devices, n being a positive integer.

The first determination module 72 is configured to, in response to detecting that m first AR devices in the n first AR devices meet a preset presentation condition for triggering virtual object presentation, determine presentation data matched with the m first AR devices respectively and including a moving state of a virtual object based on a movement position of the virtual object and the position data of the m first AR devices, m being a positive integer less than or equal to n.

The second presentation module 73 is configured to present AR data including the presentation data matched with the m first AR devices respectively through the m first AR devices.

In a possible implementation mode, the presentation data in the first determination module 72 includes a moving state presented in a process that the virtual object moves along with a moving path; and points that the moving path passes by include positions of the m first AR devices, or, the points that the moving path passes by include position points in a preset distance range away from the positions of the m first AR devices respectively.

In a possible implementation mode, the apparatus further includes a second acquisition module 74 and a second determination module 75.

The second acquisition module 74 is configured to acquire position data of a second AR device.

The determination module 75 is configured to, in response to detecting that the second AR device meets the preset presentation condition, update the presentation data including the moving state of the virtual object based on a position of the virtual object in a present moving state, the position data of the second AR device and the position data of a first AR device that the moving path before updated does not pass by in the m first AR devices.

In some embodiments, functions or templates of the apparatus provided in the embodiment of the disclosure may be configured to execute the method described in the method embodiments and specific implementations thereof may refer to the descriptions about the method embodiments and, for simplicity, will not be elaborated herein.

Based on the same technical concept, the embodiments of the disclosure also provide a first electronic device. Referring to FIG. 8, a structure diagram of a first electronic device according to an embodiment of the disclosure is shown. The first electronic device 800 includes a first processor 801, a first memory 802 and a first bus 803. The first memory 802 is configured to store an executable instruction, and includes a first internal storage 8021 and a first external memory 8022. Here, the first internal storage 8021, also called an internal memory, is configured to temporarily store arithmetic data in the first processor 801 and data exchanged with the first external memory 8022 such as a hard disk. The first processor 801 performs data exchange with the first external memory 8022 through the first internal storage 8021.

The first processor 801 may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a controller, a microcontroller and a microprocessor.

The first internal storage 8021 or the first external memory 8022 may be implemented by a volatile or non-volatile storage device of any type or a combination thereof, for example, a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

When the first electronic device 800 runs, the first processor 801 communicates with the first memory 802 through the first bus 803 such that the first processor 801 can execute operations including:

acquiring position data of an AR device;

in response to detecting that the AR device meets a preset presentation condition for triggering virtual object presentation, determining presentation data including a moving state of a virtual object based on a movement position of the virtual object and the position data of the AR device; and

presenting AR data including the presentation data through the AR device.

A specific processing process executed by the first processor 801 may refer to the related descriptions in the method embodiments or the corresponding apparatus embodiments, and will not be described herein.

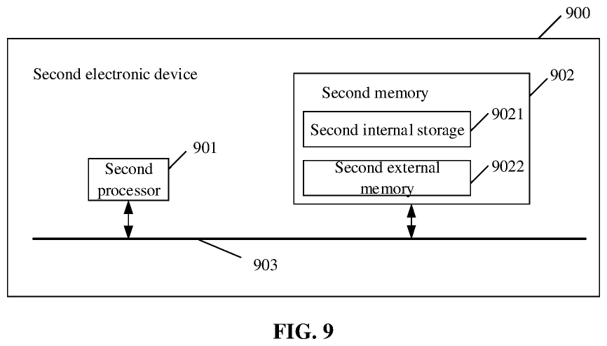

Based on the same technical concept, the embodiments of the disclosure also provide a second electronic device. Referring to FIG. 9, a structure diagram of a second electronic device according to an embodiment of the disclosure is shown. The second electronic device 900 includes a second processor 901, a second memory 902 and a second bus 903. The second memory 902 is configured to store an executable instruction, and includes a second internal storage 9021 and a second external memory 9022. Here, the second internal storage 9021, also called an internal memory, is configured to temporarily store arithmetic data in the second processor 901 and data exchanged with the second external memory 9022 such as a hard disk. The second processor 901 may exchange data with the second external memory 9022 through the second internal storage 9021.

The second processor 901 may be at least one of: an ASIC, a DSP, a DSPD, a PLD, an FPGA, a controller, a microcontroller and a microprocessor.

The second internal storage 9021 or the second external memory 9022 may be implemented by a volatile or non-volatile storage device of any type or a combination thereof, for example, an SRAM, an EEPROM, an EPROM, a PROM, a ROM, a magnetic memory, a flash memory, a magnetic disk or an optical disk.

When the second electronic device 900 runs, the second processor 901 may communicate with the second memory 902 through the second bus 903 such that the second processor 901 can execute operations including:

acquiring position data of n first AR devices, n being a positive integer;

in response to detecting that m first AR devices in the n first AR devices meet a preset presentation condition for triggering virtual object presentation, determining presentation data matched with the m first AR devices respectively and including a moving state of a virtual object based on a movement position of the virtual object and the position data of the m first AR devices, m being a positive integer less than or equal to n; and

presenting AR data including the presentation data matched with the m first AR devices respectively through the m first AR devices.

A specific processing process executed by the second processor 901 may refer to the related descriptions in the method embodiments or the corresponding apparatus embodiments, and will not be described herein.

In addition, the embodiments of the disclosure also provide a computer-readable storage medium, in which a computer program is stored. The computer program can be operated by a processor to execute the method for presenting AR data as described in the method embodiments.

The embodiments of the disclosure also provide a computer program, which includes a computer-readable storage medium storing a program code. An instruction in the program code may execute the method for presenting AR data as described in the method embodiments, specifically referring to the method embodiments. Elaborations are omitted herein.

It can be clearly learned by those skilled in the art that specific operation processes of the system and device described above may refer to the corresponding processes in the method embodiments and will not be elaborated herein for convenient and brief description. In some embodiments provided by the disclosure, it is to be understood that the disclosed system, device and method may be implemented in another manner. The device embodiment described above is only schematic. For example, division of the units is only logic function division, and other division manners may be adopted during practical implementation. For another example, multiple units or components may be combined or integrated into another system, or some characteristics may be neglected or not executed. In addition, coupling or direct coupling or communication connection between each displayed or discussed component may be indirect coupling or communication connection, implemented through some communication interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, or two or more than two units may also be integrated into a unit.

When realized in form of software functional units and sold or used as an independent product, the functions may also be stored in a non-volatile computer-readable storage medium executable by the processor. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the steps of the method in each embodiment of the disclosure. The storage medium includes: various media capable of storing program codes such as a U disk, a mobile hard disk, a ROM, a Random Access Memory (RAM), a magnetic disk or an optical disk.

The above is only the specific implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

### INDUSTRIAL APPLICABILITY

The embodiments of the disclosure provide a method and apparatus for presenting AR data, an electronic device, a storage medium and a program. The method includes that: position data of an AR device is acquired; in response to detecting that the AR device meets a preset presentation condition for triggering virtual object presentation, presentation data including a moving state of a virtual object is determined based on a movement position of the virtual object and the position data of the AR device; and AR data including the presentation data is presented through the AR device.

1. A method for presenting augmented reality (AR) data, comprising:
acquiring position data of an AR device;
in response to detecting that the AR device meets a preset presentation condition for triggering virtual object presentation, determining presentation data comprising a moving state of a virtual object based on a movement position of the virtual object and the position data of the AR device; and
presenting AR data comprising the presentation data through the AR device.

2. The method of claim 1, wherein the movement position of the virtual object comprises at least one of following positions:
a preset initial position of the virtual object, a preset end position of the virtual object, or a position of the virtual object in a present moving state.

3. The method of claim 1, wherein the preset presentation condition comprises that the position data of the AR device is in a target regional range.

4. The method of claim 1, wherein the preset presentation condition comprises that the position data of the AR device is in a target regional range and attribute information of a user associated with the AR device satisfies a preset attribute condition.

5. The method of claim 1, wherein determining the presentation data comprising the moving state of the virtual object based on the movement position of the virtual object and the position data of the AR device comprises:
acquiring a moving path of the virtual object based on the movement position of the virtual object and the position data of the AR device; and
generating the presentation data comprising the moving state of the virtual object based on the moving path and special effect data of the virtual object in a three-dimensional scene model matched with a reality scene.

6. The method of claim 1, further comprising:
in response to detecting that the AR device meets the preset presentation condition for triggering virtual object presentation, determining a virtual object matched with attribute information of a user associated with the AR device based on the attribute information,
wherein determining the presentation data comprising the moving state of the virtual object based on the movement position of the virtual object and the position data of the AR device comprises:
acquiring the movement position of the virtual object matched with the attribute information; and
determining the presentation data comprising the moving state of the virtual object based on the movement position of the virtual object matched with the attribute information and the position data of the AR device.

7. The method of claim 4, wherein the attribute information comprises at least one of: age of the user, gender of the user, occupational attribute of the user, or interested virtual object information preset by the user.

8. A method for presenting augmented reality (AR) data, comprising:
acquiring position data of n first AR devices, n being a positive integer;
in response to detecting that m first AR devices in the n first AR devices meet a preset presentation condition for triggering virtual object presentation, determining presentation data matched with the m first AR devices respectively and comprising a moving state of a virtual object based on a movement position of the virtual object and the position data of the m first AR devices, m being a positive integer less than or equal to n; and
presenting AR data comprising the presentation data matched with the m first AR devices respectively through the m first AR devices.

9. The method of claim 8, wherein the presentation data comprises a moving state presented in a process that the virtual object moves along with a moving path; and
points that the moving path passes by comprise positions of the m first AR devices, or, the points that the moving path passes by comprise position points in a preset distance range away from the positions of the m first AR devices respectively.

10. The method of claim 9, further comprising:
acquiring position data of a second AR device; and
in response to detecting that the second AR device meets the preset presentation condition, updating the presentation data comprising the moving state of the virtual object based on a position of the virtual object in a present moving state, the position data of the second AR device and position data of a first AR device that the moving path before updated does not pass by in the m first AR devices.

11. An electronic device, comprising: a processor and a memory capable of communicating with the processor,
wherein the processor is configured to execute instructions stored in the memory to cause the electronic device to perform operations comprising:
acquiring position data of an AR device;
in response to detecting that the AR device meets a preset presentation condition for triggering virtual object presentation, determining presentation data comprising a moving state of a virtual object based on a movement position of the virtual object and the position data of the AR device; and
presenting AR data comprising the presentation data through the AR device.

12. The electronic device of claim 11, wherein the movement position of the virtual object comprises at least one of following positions:
a preset initial position of the virtual object, a preset end position of the virtual object, or a position of the virtual object in a present moving state.

13. The electronic device of claim 11, wherein the preset presentation condition comprises that the position data of the AR device is in a target regional range.

14. The electronic device of claim 11, wherein the preset presentation condition comprises that the position data of the AR device is in a target regional range and attribute information of a user associated with the AR device satisfies a preset attribute condition.

15. The electronic device of claim 11, wherein the processor determines the presentation data comprising the moving state of the virtual object by steps of:
acquiring a moving path of the virtual object based on the movement position of the virtual object and the position data of the AR device; and
generating the presentation data comprising the moving state of the virtual object based on the moving path and special effect data of the virtual object in a three-dimensional scene model matched with a reality scene.

16. The electronic device of claim 11, wherein the processor is further configured to:
in response to detecting that the AR device meets the preset presentation condition for triggering virtual object presentation, determine a virtual object matched with attribute information of a user associated with the AR device based on the attribute information,
wherein the processor determines the presentation data comprising the moving state of the virtual object by steps of:
acquiring the movement position of the virtual object matched with the attribute information; and
determining the presentation data comprising the moving state of the virtual object based on the movement position of the virtual object matched with the attribute information and the position data of the AR device.

17. The electronic device of claim 14, wherein the attribute information comprises at least one of: age of the user, gender of the user, occupational attribute of the user, or interested virtual object information preset by the user.

18. An electronic device, comprising: a processor and a memory capable of communicating with the processor,
wherein the processor is configured to execute instructions stored in the memory to cause the electronic device to perform operations of the method of claim 8.

19. A non-transitory computer-readable storage medium, storing a computer program that, when run by a processor, executes the method for presenting augmented reality (AR) data according claim 1.

20. A non-transitory computer-readable storage medium, storing a computer program that, when run by a processor, executes the method for presenting augmented reality (AR) data according claim 8.
